(19) United States
(12) Patent Application Publication
(10) Pub. No.: US 2003/0212972 A1
(43) Pub. Date: Nov. 13, 2003

(54) Unconventional clocked circuit components having multiple timing models

(75) Inventor: Dzung Joseph Tran, Tigard, OR (US)

Correspondence Address: KLARQUIST SPARKMAN, LLP, One World Trade Center, Suite 1600, 121 S.W. Salmon Street, Portland, OR, 97204, US

(73) Assignee: Translogic Technology, Inc.

(21) Appl. No.: 10/145,068

(22) Filed: May 13, 2002

(51) Int. Cl. G06F 9/45; G06F 17/50

(52) U.S. Cl. 716/6

(57) ABSTRACT

A flip-flop is characterized at a given voltage, temperature, and process corner by generating a plurality of rise time setup tables for the flip-flop, generating a plurality of fall time setup tables for the flip-flop, generating a plurality of rise time CQ tables for the flip-flop, and generating a plurality of fall time CQ tables for the flip-flop. The multiple tables are included in at least one library.

### FIELD

The invention relates to the design and characterization of clocked circuits.

### BACKGROUND

The design of complex modem circuits typically involves several stages. A circuit component is designed and described in terms of a ‘netlist’, e.g. a data structure of points in the circuit and the electrical properties of the interconnections between the points. A common form of the netlist is SPICE (Simulation Program with Integrated Circuit Emphasis). The netlist is applied to produce a layout netlist, which is similar to the netlist but wherein the points and interconnections represent the actual physical layout of the circuit as it will be manufactured. A common format for the layout netlist is the well-known Graphic Design System (GDS) II by Calma®. The layout netlist, in turn, is applied to produce an extracted netlist. The extracted netlist may include additional points and interconnections representing capacitive and resistive effects inherent but not explicit in the layout netlist. The extracted netlist may be applied to determine a timing model for the component. The timing model describes the time-wise behavior between the component's inputs and outputs under various conditions, including loading on the outputs. Timing models are typically generated for a particular operating voltage range, temperature range, and set of fabrication conditions for the component. This is referred to as characterizing the component at a particular voltage, temperature, and process corner. The timing model of the component may be stored in a library for the component. A library typically comprises a collection of associated data that characterizes the operation of multiple components.

The timing model characterizes the component. When the component is utilized in a more extensive circuit design, the timing model may be applied to ascertain propagation delays to signals in the design that interact with the component. Signals arrive at the inputs of the component from upstream points in the circuit design, are subjected to the propagation delay of the component, and propagate to downstream points in the circuit design from the outputs of the component. Conventional components are typically designed so that propagation delays are minimized.

In clocked circuits such as flip-flops, timing is especially important because signals to the data input(s) of such devices should arrive (become valid) at the input(s) a sufficient time before the clock signal arrives to the circuit. Otherwise, setup constraints for the circuit may be violated. At a point in the circuit design, the time difference between when the data signal will arrive and when the data signal is required to arrive to meet the timing of the circuit is referred to as the slack time at the point.

One time of particular importance in the timing model of a flip-flop or other clocked component is the clock to Q delay (Tcq) of the component. Tcq is the difference between when the clock signal is received and when the signal at the data output (Q) terminal of the component becomes a valid representation of the signal at the data input (D) terminal of the component. Conventional flip-flops are designed such that Tcq does not vary by more than a small percentage (typically of the order of 10% to 20%) over the range of the setup times of the component. The range of Tcq that the component may assume is referred to as the CQ sensitivity range. The conventional approach has been to characterize the component at a single point of the CQ sensitivity range to generate one rise-time setup table, one fall-time setup table, one rise-time clock-Q (CQ) table, and one fall-time CQ table, for a particular voltage, temperature, and process corner. Unfortunately, this does always leave sufficient design flexibility to improve performance in circuits that utilize the component.

### SUMMARY

A flip-flop is characterized at a given voltage, temperature, and process corner by generating a plurality of rise time setup tables for the flip-flop, generating a plurality of fall time setup tables for the flip-flop, generating a plurality of rise time CQ tables for the flip-flop, and generating a plurality of fall time CQ tables for the flip-flop. The multiple tables are included in at least one library representing the flip-flop.

### BRIEF DESCRIPTION OF THE DRAWINGS

FIG. 1 is a block diagram of an embodiment of a circuit design employing flip-flops.

FIG. 2 is a block diagram of an embodiment of a flip-flop and illustrated embodiments of associated signal timings.

FIG. 3 comprises illustrated embodiments of clock and data signal slew rates.

FIG. 4 comprises illustrated embodiments of ranges comprising a timing model for a flip-flop or other clocked circuit component.

FIG. 5 is a flow chart of an embodiment of a method to determine a range of CQ delays in a timing model.

FIG. 6 is a flow chart of an embodiment of a method to determine multiple timing models for a clocked component.

FIG. 7 is a flow chart of an embodiment of a method to utilize a clocked component having multiple timing models in a more extensive circuit design.

FIG. 8 is an apparatus embodiment for practicing techniques of the present invention.

### DETAILED DESCRIPTION

Although presented in terms of flip-flops, the principles of the present invention apply to clocked circuit components in general. References to “a” or “an” embodiment do not necessarily refer to the same embodiment, although they may. In the figures, like numbers refer to like elements.

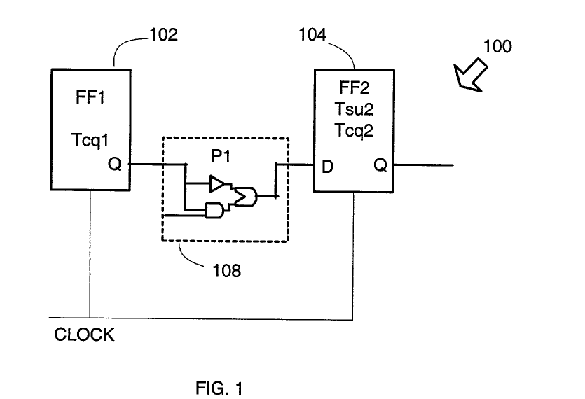

FIG. 1 is a circuit embodiment comprising flip-flops in series such that a signal received by a first flip-flop 102 is later propagated to a second flip-flop 104. The flip-flop 102 has a CQ delay Tcq1. The flip-flop 104 has a CQ delay Tcq2 and a setup time Tsu2. The signal path between flip-flop 102 and flip-flop 104 comprises combinational logic 108 that delays the propagation of a signal between the flip-flops 102, 104 by an amount of time P1. A clock signal CLOCK is applied to each of the flip-flops 102, 104. A minimum period of CLOCK is determined according to Tcq1+P1+Tsu2.

One or more of the flip-flops 102,104 is unconventional. As used herein, the term “unconventional” as applied to circuit components indicates a component designed to have a CQ sensitivity range significantly in excess of conventional designs. For example, for the flip-flops 102,104, the time Ts (the difference in arrival times of the data signal and the clock signal to the flip-flops) may be varied to produce variations in Tcq substantially beyond the variations that would be possible using a conventional flip-flop. In other words, Tcq has a range in the unconventional design that is substantially beyond the range of Tcq in conventional designs. As previously described, the range of Tcq for a component is called the component's CQ sensitivity range. Conventional flip-flop are designed to have a minimum Tcq, Tcqmin, and to have an operating range within which variations in Ts do not produce values of Tcq beyond Tcqmin plus some small percentage (such as Tcqmin*1.1 or thereabout). Thus the CQ sensitivity range in such designs is low.

Although it may seem counterintuitive to deliberately design a clocked circuit component to have a CQ sensitivity range that is substantially greater than conventional designs, the reality is that when associated with multiple timing models, such unconventional circuits may provide substantial performance improvements in circuits.

Unlike the conventional approach of characterizing the component at one point of the CQ sensitivity range where changes in Ts produce minimal changes in Tcq, the component may instead be characterized at multiple points of the CQ sensitivity range for a particular operating voltage range, temperature range, and fabrication process corner for the component. In this manner, the present invention actually exploits that which has previously been viewed as a disadvantage, namely, an unconventionally large CQ sensitivity range.

Consider an embodiment in which Tcq1=0.5 ns (nanoseconds), P1=1 ns, Tsu2=0.5 ns, and Tcq2=0.5 ns. Thus the timing model for the flip-flop 104 defines a setup time of 0.5 ns and a corresponding CQ delay of 0.5 ns. In conventional approaches these may be the only timing models available for the flip-flop 104 (at least, the only model available for a particular operating voltage, temperature range, etc.). For a CLOCK having a period of 1.7 ns, the slack time at the D input of flip-flop 104 is 1.7 ns−(0.5 ns+1 ns+.5 ns)=−0.3 ns. The data signal arrives at the D input of the flip-flop 104 0.3 ns (300 picoseconds) too late to meet the timing of the circuit. The negative slack time indicates that the circuit will not function properly using the flip-flop 104.

However, consider the case where the flip-flop 104 is unconventional, and may operate at a setup time of 0.2 ns with a corresponding increase in CQ delay to 0.7 ns. Where there are multiple timing models for the flip-flop 104, one of which defines a setup time of 0.2 ns and a corresponding CQ delay of 0.7 ns, this latter timing model may be employed when performing slack-time analysis of the circuit because it improves the slack time at points upstream from the flip-flop 104. Employing this timing model, again for a CLOCK having a period of 1.7 ns, the slack time at the D input of flip-flop 104 is 1.7 ns (0.5 ns+1 ns+0.2 ns)=0 ns. The zero slack time indicates that the flip-flop 104 has met the timing of the circuit, and may be employed in the design after all, provided that the increase in Tcq2 is tolerable.

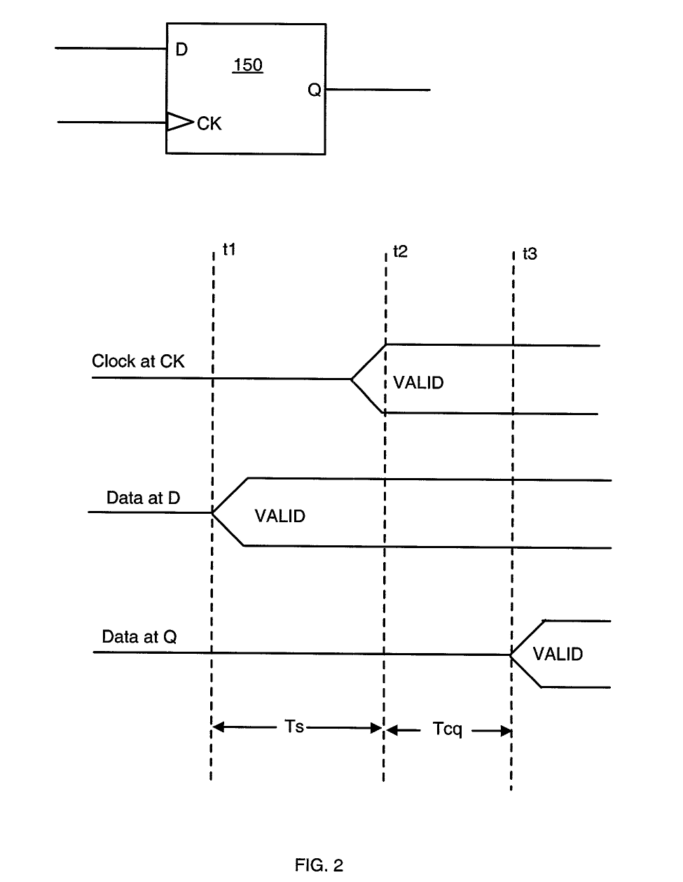

FIG. 2 illustrates the inputs and outputs of an unconventional flip-flop 150. A data signal arrives (becomes valid) at the D terminal at a time t1. A clock signal arrives at the CK terminal at time t2 and causes the signal at the output terminal Q to assume the value of the data signal at time t3. The difference in the arrival times of the data and clock signals is the setup time Ts. The difference between the arrival time of the clock signal and the time when the signal at Q is a valid representation of the signal at D is Tcq.

As Ts approaches zero, Tcq increases until a point is reached at which the flip-flop 150 no longer operates properly. For a conventional flip-flop, a decreasing Ts typically does not increase Tcq to more than Tcqmin*1.X, where X is a small number (typically less than 2). For an unconventional flip-flop, a decreasing Ts can increase Tcq to Tcqmin*Y.X, where Y can be 1, 2, or more, and X can be any number. Thus, an unconventional flip-flop may comprise a CQ sensitivity range of Tcqmin+100% and even higher.

Another characteristic of the flip-flop 150 is the range of output loads that it is designed to support. The output load on the flip-flop is typically resistive or capacitive or both. Within a range of output loads Q1min (minimum supported load) and Q1max (maximum supported load), the flip-flop operates as the designer intended.

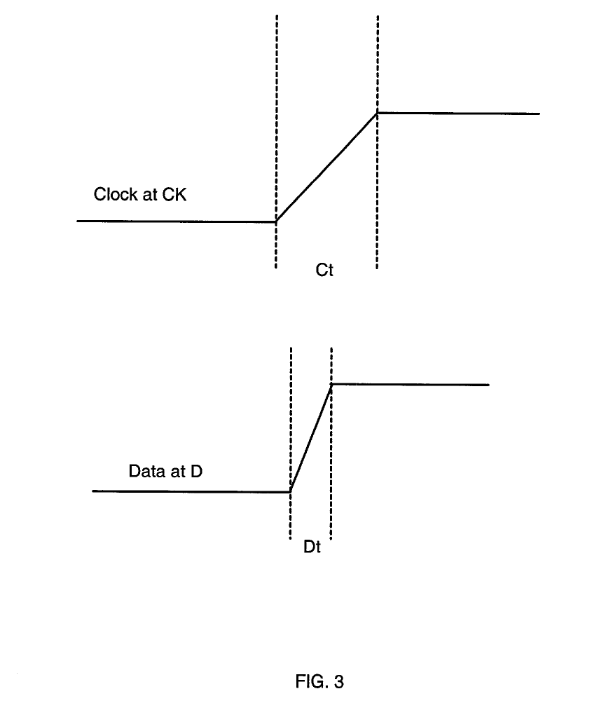

FIG. 3 illustrates embodiments of clock and data signals to a flip-flop. Each signal has a slew rate that determines its transition interval. The transition interval of a signal is the time it takes the signal to change levels. At some time within the transition interval, the clock signal becomes valid. The transition interval of the clock signal to a flip-flop is Ct. The slew rate of the clock signal may vary, resulting in a range of values for Ct. Ct may vary between a minimum value Ctmin (fast-transitioning clock signal) and Ctmax (slow-transitioning clock signal). The transition interval of the data signal to a flip-flop is Dt. At some time within the transition interval, the data signal becomes valid. The slew rate of the data signal may vary, resulting in a range of values for Dt. Dt may vary between a minimum value Dtmin (fast-transitioning data signal) and Dtmax (slow-transitioning data signal).

A signal may exhibit different slew rates for low-to-high and high-to-low transitions. Thus, Ct and Dt may vary according to whether the signal is transitioning low-to-high or high-to-low.

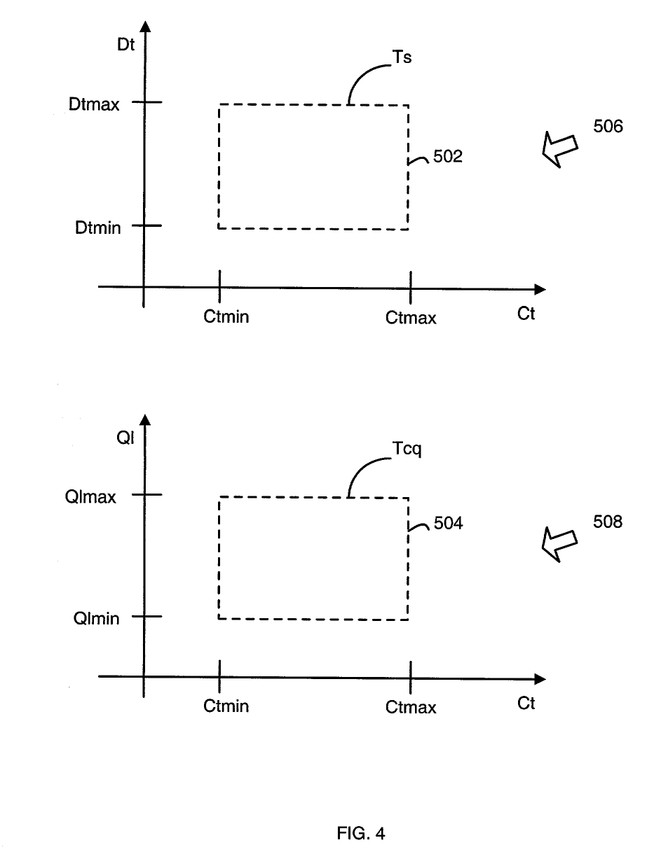

FIG. 4 illustrates timing model embodiments for a flip-flop. In a first model 506, Ct and Dt are varied over their respective intervals Ctmin, Ctmax and Dtmin, Dtmax to determine a set 502 of Ct, Dt pairs. A value of Ts is determined for each Ct, Dt pair in the set. Due to the potential differences between rising and falling slew rates, a table like 502 may be generated for both high-to-low (rising) and low-to-high (falling) transitions of the data signal. The table 502 provides a model of the setup timing of the data signal to the component. These tables may be referred to as the rise time setup table and fall time setup table, respectively.

In a second timing model 508, Ct and Q1 are varied over their respective intervals Ctmin, Ctmax and Q1min, Q1max to determine a set 504 of Ct, Q1 pairs. A value of Tcq is determined for each Ct, Q1 value pair of the set 504. The table 504 provides a model of the CQ timing of the component. Due to the potential differences between rising and falling slew rates, a table like 504 may be generated for both high-to-low (rising) and low-to-high (falling) transitions of the data signal. These tables may be referred to as the rise time CQ table and fall time CQ table, respectively.

In some embodiments the sets may begin at greater than the minimum values of Ct, Dt, and Q1, and may extend to less than the maximum values. In some embodiments the sets 502 and 504 may be stored together, e.g. stored as a single set or table although capable of being interpreted separately.

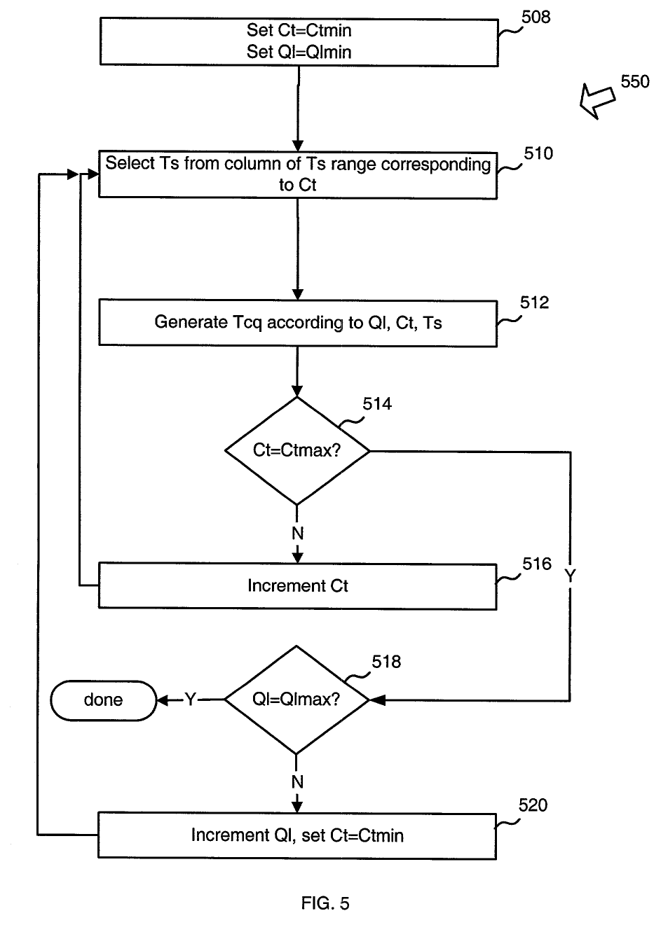

FIG. 5 is a flow chart of an embodiment 550 of a method of determining a value Tcq for each Ct, Q1 pair in a column (fixed Ct value) of the set 504. At 508 the value of Q1 is set to Q1min. At 510 a value of Tsu corresponding to Ct is selected from the set 502.

In one embodiment, the value of Tsu corresponding to Ct, Dtmin is selected. In another embodiment, the value of Tsu corresponding to Ct, (Dtmax−Dtmin)/2 is selected. In general, the value of Tsu may be selected from the appropriate column of set 502 as the application dictates. At 512 the value of Tcq at point Ct, Q1 in the set 504 is then determined according to Ct, Q1, and the selected value of Tsu. If at 514 it is determined that the value Ct is or exceeds Ctmax, the method skips to 518 to determine if Q1 is or exceeds Q1max. If so, the method 550 concludes. Otherwise, Q1 is incremented at 520 by some amount and processing continues at 510.

Other manners of traversing the ranges Ctmin, Ctmax and Q1min, Q1max may also be employed. For example, Ct and Q1 could be set to their maximum range values and then decremented upon each iteration.

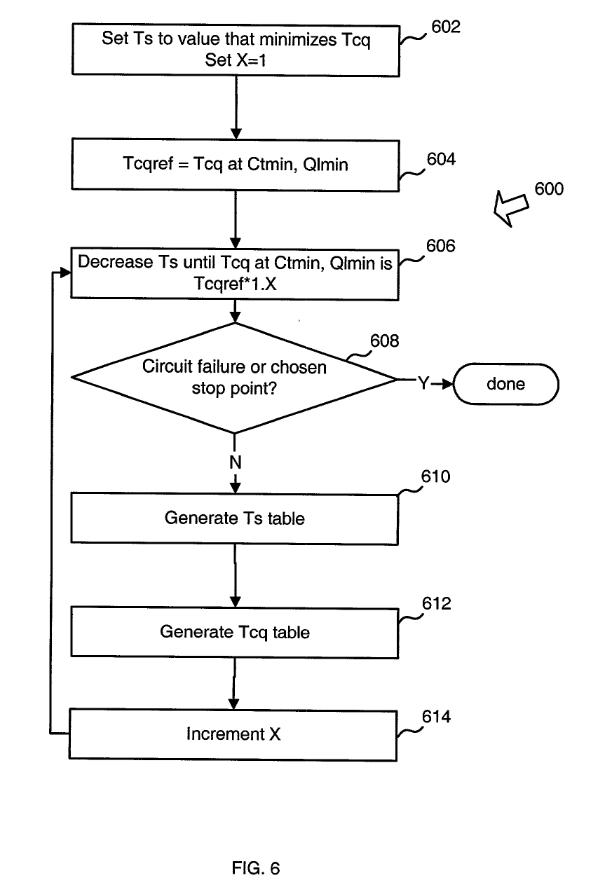

FIG. 6 shows an embodiment 600 of a method to determine multiple timing models for an unconventional clocked component. At 602 Ts is set to a (typically large) value that minimizes Tcq for a particular design. A scale value X is initialized to unity (1). At 604 a value of Tcq is determined using this Ts and the values Ctmin, Q1min. This value of Tcq is referred to herein as Tcqref, e.g. the ‘reference value’ of Tcq. The reference value could also be chosen from another member of the set 504. At 606 the value of Ts is decreased until the value of Tcq at Ctmin, and Q1min is Tcqref1.X. Each value Tcqref*1.X is referred to herein as a point in the CQ sensitivity range of the component. If, at 608, decreasing Ts to this point results in circuit failure, or if a predetermined stop point is reached (for example, Tcq falls outside the CQ sensitivity range), the method concludes. Otherwise, at 610 the set 502 of Tsu is determined over the ranges Ctmin, Ctmax and Dtmin, Dtmax. At 612, the set 504 of Tcq for possible output loads Q1min, Q1max on the component is determined from the set 502 of Tsu, in manners in accordance with the embodiments previously described. At 614 the value of X is incremented and the method returns to 606.

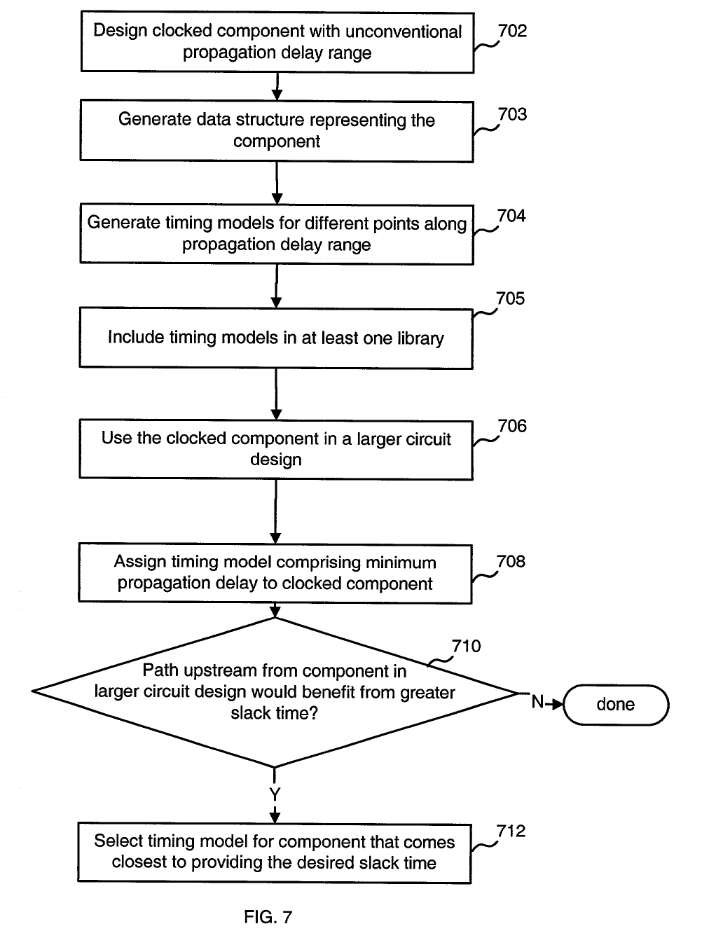

FIG. 7 illustrates an embodiment 700 of a method to increase the design flexibility and/or reliability of circuit designs employing flip-flops. At 702 a component is designed with a certain CQ sensitivity range. At 703 data structures, typically netlist-type data structures in SPICE and GDS II form, are produced for the design. At 704, multiple timing models are generated for the component, each timing model corresponding a point in the component's CQ sensitivity. The multiple timing models are included in at least one library representing the component at 705. Although the timing models may be included in multiple libraries (for example, one setup table and one CQ table per library), the timing models are all produced from the same SPICE and/or GDS II netlists for the component. At 706 the component is employed in a circuit design. At 708 the timing model comprising the minimum Tcq for the component is assigned to the component. It is determined at 710 whether or not the points upstream of the component in the design could benefit from greater slack time. If not, the method concludes. If so, at 712 a timing model is selected that comes closest to providing the desired slack time is selected from at least one libraries.

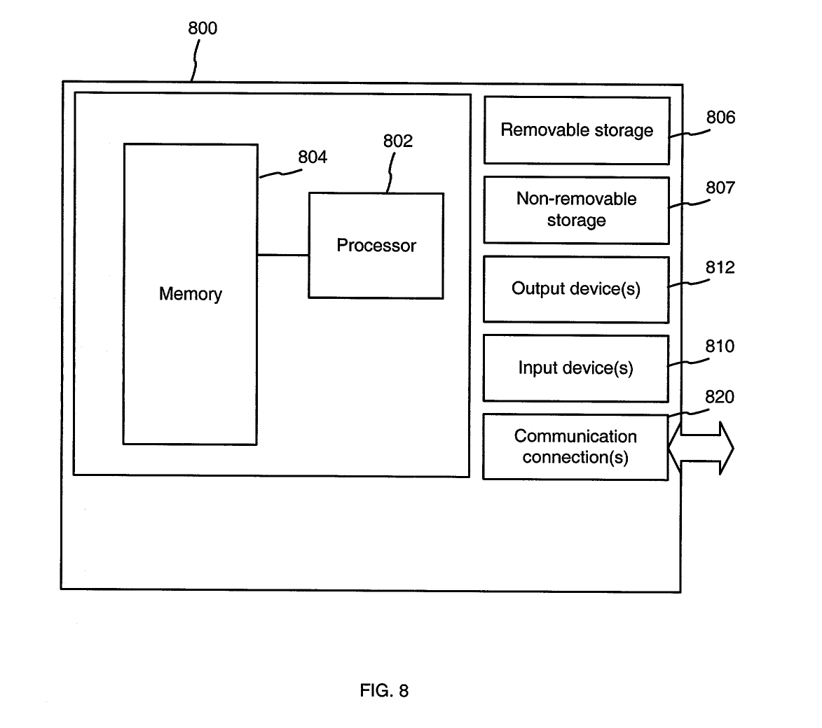

With reference to FIG. 8, an apparatus embodiment 800 for practicing embodiments of the present invention comprises a processing unit 802 (e.g., a processor, microprocessor, micro-controller, etc.) and machine-readable media 804. The apparatus may is an embodiment of a “computer system”, although in general a computer system can be any device comprising a processor and a memory, the memory to store instructions to supply to the processor for execution. Depending on the configuration and application (mobile, desktop, server, etc.), the memory 804 may be volatile (such as RAM), non-volatile (such as ROM, flash memory, etc.) or some combination of the two. By way of example, and not limitation, the machine readable media 804 may comprise volatile and/or nonvolatile media, removable and/or non-removable media, including: RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information to be accessed by the apparatus 800. The machine readable media 804 may be implemented in any method or technology for storage of information such as computer readable instructions, data structures, program modules or other data. Such instructions and data may, when executed by the processor 802, carry out embodiments of methods in accordance with the present invention.

The apparatus 800 may comprise additional storage (removable 806 and/or non-removable 807) such as magnetic or optical disks or tape. The apparatus 800 may further comprise input devices 810 such as a keyboard, pointing device, microphone, etc., and/or output devices 812 such as display, speaker, and printer. The apparatus 800 may also typically include network connections 820 (such as a network adapter) for coupling to other devices, computers, networks, servers, etc. using either wired or wireless signaling media.

The components of the device may be embodied in a distributed computing system. For example, a terminal device may incorporate input and output devices to present only the user interface, whereas processing component of the system are resident elsewhere. Likewise, processing functionality may be distributed across a plurality of processors.

The apparatus may generate and receive machine readable instructions, data structures, program modules or other data in a modulated data signal such as a carrier wave or other transport mechanism. The term “modulated data signal” means a signal that has one or more of its characteristics set or changed in such a manner as to encode information in the signal. This can include both digital, analog, and optical signals. By way of example, and not limitation, communication media includes wired media such as a wired network or direct-wired connection, and wireless media such as acoustic, RF, infrared and other wireless media. Communications media, including combinations of any of the above, should be understood as within the scope of machine readable media.

Particular embodiments of a method and apparatus have been described herein. Many alternative embodiments will now become apparent to those skilled in the art. It should be recognized that the described embodiments are illustrative only and should not be taken as limiting in scope. Rather, the present invention encompasses all such embodiments as may come within the scope of the following claims and equivalents thereto.

What is claimed:

1. A method of characterizing a flip-flop at a particular voltage, temperature, and process corner, the method comprising:
at each of a plurality of points of a CQ sensitivity range of the flip-flop, generating a plurality of tables, each table comprising at least one of a plurality of propagation delays and a plurality of setup times for the flip-flop; and
including the tables in at least one library.

2. The method of claim 1 further comprising:
generating the multiple tables according to at least one of the same SPICE netlist and the same GDSII layout netlist.

3. The method of claim 1 wherein at least one table at each point comprises a plurality of rise time setup times for the flip-flop, each setup time determined from at least a Ct, Dt value pair.

4. The method of claim 1 wherein at least one table at each point comprises a plurality of fall time setup times for the flip-flop, each setup time determined from at least a Ct, Dt value pair.

5. The method of claim 1 wherein at least one table at each point comprises a plurality of rise time CQ delays for the flip-flop, each CQ delay determined from at least a Ct, Q1 value pair.

6. The method of claim 1 wherein at least one table at each point comprises a plurality of fall time CQ delays for the flip-flop, each CQ delay determined from at least a Ct, Q1 value pair.

7. The method of claim 1 further comprising:
at each of at least three points of a CQ sensitivity range of the flip-flop, generating the multiple tables.

8. A method of characterizing a clocked component at a particular voltage, temperature, and process corner, the method comprising:
at each of a plurality of points of a CQ sensitivity range of the component, generating multiple timing models, each timing model comprising at least one of a plurality of propagation delays and a plurality of setup times for the component; and
including the timing models in at least one library.

9. The method of claim 8 further comprising:
generating the multiple timing models according to at least one of the same SPICE netlist and the same GDSII layout netlist.

10. The method of claim 8 wherein at least one timing model at each point comprises a plurality of rise time setup times for the circuit, each setup time determined from at least a Ct, Dt value pair.

11. The method of claim 8 wherein at least one timing model at each point comprises a plurality of fall time setup times for the circuit, each setup time determined from at least a Ct, Dt value pair.

12. The method of claim 8 wherein at least one timing model at each point comprises a plurality of rise time CQ delays for the circuit, each CQ delay determined from at least a Ct, Q1 value pair.

13. The method of claim 8 wherein at least one timing model at each point comprises a plurality of fall time CQ delays for the circuit, each CQ delay determined from at least a Ct, Q1 value pair.

14. The method of claim 8 further comprising:
at each of at least three points of the CQ sensitivity range of the flip-flop, generating the multiple tables.

15. An article comprising:
a machine-readable media comprising data representing at least one component libraries, the at least one libraries comprising
multiple timing models at different points of a CQ sensitivity of a component;
each timing model comprising at least one of a plurality of propagation delays and a plurality of setup times for the component;
the multiple timing models for a single netlist for the component.

16. The article of claim 15 wherein each timing model comprises a plurality of rise time setup times for the circuit, each setup time of the set determined from at least a Ct, Dt value pair.

17. The article of claim 15 wherein each timing model comprises a plurality of fall time setup times for the circuit, each setup time of the set determined from at least a Ct, Dt value pair.

18. An article comprising:
a machine-readable media comprising at least one component libraries, the at least one libraries comprising:
multiple tables generated at each of a plurality of points of a CQ sensitivity range of a flip-flop, the multiple tables generated at a particular voltage, temperature, and process corner of the flip-flop and from the same netlist for the flip-flop, each table comprising at least one of a plurality of propagation delays and a plurality of setup times for the flip-flop.

19. The article of claim 18 wherein at least one table at each point comprises a plurality of rise time setup times for the flip-flop, each setup time determined from at least a Ct, Dt value pair.

20. The article of claim 18 where at least one table at each point comprises a plurality of fall time setup times for the flip-flop, each setup time determined from at least a Ct, Dt value pair.

21. The article of claim 18 wherein at least one table at each point comprises a plurality of rise time CQ delays for the flip-flop, each CQ delay determined from at least a Ct, Q1 value pair.

22. The article of claim 18 wherein at least one table at each point comprises a plurality of fall time CQ delays for the flip-flop, each CQ delay determined from at least a Ct, Q1 value pair.

23. The article of claim 18 further comprising tables generated at each of at least three points of the CQ sensitivity range of the flip-flop.

24. A method of characterizing a flip-flop at a given voltage, temperature, and process corner, the method comprising:
generating a plurality of rise time setup tables for the flip-flop;
generating a plurality of fall time setup tables for the flip-flop;
generating a plurality of rise time CQ tables for the flip-flop;
generating a plurality of fall time CQ tables for the flip-flop; and
including the multiple tables in at least one library.

25. The method of claim 24 further comprising:
generating the multiple tables according to at least one of the same SPICE netlist and the same GDSII layout netlist.

26. The method of claim 24 wherein each rise time setup time table comprises a plurality of setup times each determined from at least a Ct, Dt value pair.

27. The method of claim 24 wherein each fall time setup time table comprises a plurality of setup times each determined from at least a Ct, Dt value pair.

28. The method of claim 24 wherein each rise time CQ table comprises a plurality of CQ delays each determined from at least a Ct, Q1 value pair.

29. The method of claim 24 wherein each fall time CQ table comprises a plurality of CQ delays each determined from at least a Ct, Q1 value pair.

30. The method of claim 24 further comprising:
generating at least three rise time setup tables for the flip-flop;
generating at least three fall time setup tables for the flip-flop;
generating at least three rise time CQ tables for the flip-flop;
generating at least three fall time CQ tables for the flip-flop; and
generating the multiple tables according to at least one of the same SPICE netlist and the same GDSII layout netlist.

31. An article comprising:
a machine-readable media comprising at least one component libraries, the at least one libraries comprising tables generated at a particular voltage, temperature, and process corner of a flip-flop, the at least one libraries comprising:
a plurality of rise time setup tables for a flip-flop;
a plurality of fall time setup tables for the flip-flop;
a plurality of rise time CQ tables for the flip-flop; and
a plurality of fall time CQ tables for the flip-flop;
the tables generated from the same at least one of a SPICE netlist and a GDSII netlist.

32. The article of claim 31 wherein each rise time setup time table comprises a plurality of setup times each determined from at least a Ct, Dt value pair.

33. The article of claim 31 wherein each fall time setup time table comprises a plurality of setup times each determined from at least a Ct, Dt value pair.

34. The article of claim 31 wherein each rise time CQ table comprises a plurality of CQ delays each determined from at least a Ct, Q1 value pair.

35. The article of claim 31 wherein each fall time CQ table comprises a plurality of CQ delays each determined from at least a Ct, Q1 value pair.

36. The article of claim 31 wherein the at least one libraries comprise:
at least three rise time setup tables for the flip-flop;
at least three fall time setup tables for the flip-flop;
at least three rise time CQ tables for the flip-flop; and
at least three fall time CQ tables for the flip-flop.
